(19) United States
(12) Patent Application Publication
(10) Pub. No.: US 2022/0279396 A1
(43) Pub. Date: Sep. 1, 2022

(54) METHODS, DEVICES AND COMPUTER READABLE MEDIA FOR SIMULTANEOUS CONNECTIVITY BASED HANDOVER

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 17/632,106

(22) PCT Filed: Aug. 2, 2019
(86) PCT No.: PCT/CN2019/099136

§ 371 Date: Feb. 1, 2022

(51) Int. Cl. H04W 36/00; H04W 52/40

(52) U.S. Cl. CPC H04W 36/0069; H04W 36/0072; H04W 52/40

(57) ABSTRACT

Embodiments of the present disclosure relate to methods, devices and computer readable medium for simultaneous connectivity based handover. In an embodiment of the present disclosure, a method for simultaneous connectivity based handover is performed at a network device as a target network device of handover. In the method, a handover request message is received from a source network device, the handover request message containing transmission capability of a terminal device to be handed over. Based on information contained in the handover request message, transmission capability coordination is performed to determine transmission parameter configuration for the target network device and a transmission capability coordination result. A handover response message is then transmitted to the source network device, to inform the source network device of the determined transmission parameter configuration for the target network device and the transmission capability coordination result.

### FIELD OF THE INVENTION

The non-limiting and exemplary embodiments of the present disclosure generally relate to the field of wireless communication techniques, and more particularly relate to methods, devices and computer readable media for simultaneous connectivity based handover in a wireless communication system.

### BACKGROUND OF THE INVENTION

This section introduces aspects that may facilitate better understanding of the disclosure. Accordingly, the statements of this section are to be read in this light and are not to be understood as admissions about what is in the prior art or what is not in the prior art.

New radio access system, which is also called as NR system or NR network, is the next generation communication system. The third generation Partnership Project (3GPP) working group was already approved the study of the NR system. The NR system will consider frequency ranging up to 100 Ghz with an object of a single technical framework addressing all usage scenarios, requirements and deployment scenarios, which includes requirements such as enhanced mobile broadband, massive machine-type communications, and ultra-reliable and low latency communications.

In the wireless communication system, such as a Long Term Evolution (LTE) system or the NR system a handover process might occur due to some reasons for example, when a terminal device moves from an area covered by one cell to an area covered by another cell, when the communication quality is too bad or the like. By means of the handover process, it is possible to transfer an ongoing call or data session from a source cell to a target cell.

The handover process might cause a delay due to communication connection transferring. In order to reduce handover interruption, simultaneous connectivity based handover seems promising for both the Long Term Evolution (LTE) system and the NR system. The main idea of simultaneous connectivity based handover is to connect with both the source cell and the target cell simultaneously during handover procedure and release communication connection with the source cell only after the terminal device establishes communication connection with the target cell successfully. Due to the simultaneous connectivity, both the source call and the target cell can serve the terminal device during the handover procedure, thus the communication delay can be reduced and in turn mobility enhancement can be achieved.

However, it requires a capacity coordination solution to enable simultaneous connectivity based handover to determine transmission configuration to be used for the source cell and the target cell during the handover process. Besides, in the existing solutions, an RRC re-establishment will be initiated if the UE's capability is exceeded during handover. Such an RRC re-establishment will take a longer time, which causes undesirable communication delay for the terminal device.

### SUMMARY OF THE INVENTION

In general, example embodiments of the present disclosure provide a new solution for simultaneous connectivity based handover in a wireless communication system.

According to a first aspect of the present disclosure, there is provided a method for simultaneous connectivity based handover. The method may be implemented at a first network device like a target network device of handover. The method may include receiving a handover request message from a source network device, the handover request message containing transmission capability of a terminal device to be handed over; performing transmission capability coordination based on at least the transmission capability of the terminal device to determine transmission parameter configuration for the target network device and a transmission capability coordination result; and transmitting a handover response message containing the transmission parameter configuration for the target network device and the transmission capability coordination result to the source network device.

According to a second aspect of the present disclosure, there is provided a method for simultaneous connectivity based handover. The method may be implemented at a second network device such as a source network device of handover. The method may include transmitting a handover request message to a target network device, the handover request message containing transmission capability of a terminal device to be handed over; receiving a handover response message containing transmission parameter configuration for the target network device and a transmission capability coordination result from the target network device; and in response to determining that the transmission capability of the terminal device is exceeded, determining transmission parameter reconfiguration for the network device based on the transmission capability coordination result.

According to a third aspect of the present disclosure, there is provided a method for simultaneous connectivity based handover. The method may be implemented at a terminal device such as UE to be handed over. The method may include receiving from a source network device serving the terminal device, a handover command message containing a transmission parameter configuration for a target network device; and performing the simultaneous connectivity based handover based on the transmission parameter configuration for the target network device and transmission parameter configuration for the source network device, wherein the transmission parameter configuration for the source network device includes one of currently used parameter configuration for the source network device and transmission parameter reconfiguration for the source network device transmitted from the source network device.

According to a fourth aspect of the present disclosure, there is provided a method for simultaneous connectivity based handover. The method may be implemented at a first network device like a target network device of handover. The method may include receiving a handover request message from a source network device, the handover request message containing transmission capability coordination result, and transmission capability of a terminal device to be handed over; determining transmission parameter configuration for the network device based on the transmission capability coordination result and transmission capability of the terminal device; and transmitting a handover response message containing the transmission parameter configuration for the target network device to the source network device.

According to a fifth aspect of the present disclosure, there is provided a method for simultaneous connectivity based handover. The method may be implemented at a second network device such as a source network device of handover. The method may include performing transmission capability coordination based on the transmission capability of a terminal device to determine transmission parameter configuration for the source network device and transmission capability coordination result; transmitting a handover request message to the target network device, the handover request message containing transmission capability coordination result, and the transmission capability of the terminal device to be handed over; and receiving a handover response message containing a transmission parameter configuration for the target network device.

According to a sixth aspect of the present disclosure, there is provided a network device. The network device may be for example a target network device of handover. The network device may include at least one processor and at least one memory coupled with the at least one processor. The at least one memory has computer program codes stored therein which are configured to, when executed on the at least one processor, cause the network device to perform operations of any of the first aspect and the fourth aspect.

According to a seventh aspect of the present disclosure, there is provided another network device. The other network device may be for example a source network device of handover. The other network device may include at least one processor and at least one memory coupled with the at least one processor. The at least one memory has computer program codes stored therein which are configured to, when executed on the at least one processor, cause the other network device to perform operations of any of the second aspect and the fifth aspect.

According to an eighth aspect of the present disclosure, there is provided a terminal device. The terminal device may be for example UE to be handed over. The terminal device may include at least one processor and at least one memory coupled with the at least one processor. The at least one memory has computer program codes stored therein which are configured to, when executed on the at least one processor, cause the terminal device to perform operations of the third aspect.

According to a ninth aspect of the present disclosure, there is provided a computer-readable storage medium having a computer program stored thereon which, when executed by at least one processor of a device, causes the device to perform actions in the method according to any embodiment in any of the first and fourth aspects.

According to a tenth aspect of the present disclosure, there is provided a computer-readable storage medium having a computer program stored thereon which, when executed by at least one processor of a device, causes the device to perform actions in the method according to any embodiment in any of the second and fifth aspects.

According to a eleventh aspect of the present disclosure, there is provided a computer-readable storage medium having a computer program stored thereon which, when executed by at least one processor of a device, causes the device to perform actions in the method according to any embodiment in the third aspect.

According to a twelfth aspect of the present disclosure, there is provided a computer program product comprising a computer-readable storage medium according to the ninth aspect.

According to a thirteen aspect of the present disclosure, there is provided a computer program product comprising a computer-readable storage medium according to the tenth aspect.

According to an fourth aspect of the present disclosure, there is provided a computer program product comprising a computer-readable storage medium according to the eleventh aspect.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 schematically illustrates an example solution of simultaneous connectivity based handover process according to embodiments of the present application;

FIG. 2 illustrates a method for simultaneous connectivity based handover at the target network device according to embodiments of the present disclosure;

FIG. 3 illustrates a method for simultaneous connectivity based handover at the source network device according to embodiments of the present disclosure;

FIG. 4 illustrates a method for simultaneous connectivity based handover at the terminal device according to embodiments of the present disclosure;

FIG. 5 illustrates some example handover processes according to embodiments of the present disclosure;

FIG. 6 illustrates another example solution of simultaneous connectivity based handover process according to embodiments of the present disclosure;

FIG. 7 illustrates a method for simultaneous connectivity based handover at the target network device according to embodiments of the present disclosure;

FIG. 8 illustrates a method for simultaneous connectivity based handover at the source network device according to embodiments of the present disclosure;

FIG. 9 schematically illustrates a simplified block diagram of a communication system 900 that can implement the simultaneous connectivity based handover process according to embodiments of the present disclosure.

### DETAILED DESCRIPTION OF EMBODIMENTS

Hereinafter, the solutions as provided in the present disclosure will be described in details through embodiments with reference to the accompanying drawings. It should be appreciated that these embodiments are presented only to enable those skilled in the art to better understand and implement the present disclosure, not intended to limit the scope of the present disclosure in any manner. For example, features illustrated or described as part of one embodiment may be used with another embodiment to yield still a further embodiment. In the interest of clarity, not all features of an actual implementation are described in this specification.

In the accompanying drawings, various embodiments of the present disclosure are illustrated in block diagrams, flow charts and other diagrams. Each block in the flowcharts or blocks may represent a module, a program, or a part of code, which contains one or more executable instructions for performing specified logic functions, and in the present disclosure, a dispensable block is illustrated in a dotted line. Besides, although these blocks are illustrated in particular sequences for performing the steps of the methods, as a matter of fact, they may not necessarily be performed strictly according to the illustrated sequence. For example, they might be performed in reverse sequence or simultaneously, which is dependent on natures of respective operations. It should also be noted that block diagrams and/or each block in the flowcharts and a combination of thereof may be implemented by a dedicated hardware-based system for performing specified functions/operations or by a combination of dedicated hardware and computer instructions.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “wireless communication network” refers to a network following any suitable wireless communication standards, such as New Radio (NR), Long Term Evolution (LTE), LTE-Advanced (LTE-A), Wideband Code Division Multiple Access (WCDMA), High-Speed Packet Access (HSPA), and so on. The “wireless communication network” may also be referred to as a “wireless communication system.” Furthermore, communications between network devices, between a network device and a terminal device, or between terminal devices in the wireless communication network may be performed according to any suitable communication protocol, including, but not limited to, Global System for Mobile Communications (GSM), Universal Mobile Telecommunications System (UMTS), Long Term Evolution (LTE), New Radio (NR), wireless local area network (WLAN) standards, such as the IEEE 802.11 standards, and/or any other appropriate wireless communication standard either currently known or to be developed in the future.

As used herein, the term “network device” refers to a node in a wireless communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, a first information may be transmitted to the terminal device from the first network device and a second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As a yet another example, in an Internet of Things (IOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a downlink (DL) transmission refers to a transmission from a network device to UE, or from a network device as a parent node to another network device as a child node, and an uplink (UL) transmission refers to a transmission in an opposite direction.

As mentioned above, simultaneous connectivity based handover seems promising for both the Long Term Evolution (LTE) system and the NR system due to reduced handover interruption. However, a capacity coordination solution is necessary for simultaneous connectivity based handover and there is still no a desirable capacity coordination solution in the existing communication system. Besides, an RRC re-establishment in case of the UE's capability being exceeded would cause an undesirable communication delay for the terminal device as well.

Embodiments of the present disclosure provide a new solution for simultaneous connectivity based handover in a wireless communication to mitigate or at least alleviate at least one of the above problems. In some embodiments of the present disclosure, a handover solution is based on an idea that a target network device performs the capability coordination in response to a handover request from a source network device. In some embodiments of the present disclosure, another handover solution is based on an idea that the source network device performs the capability coordination and transmits a handover request containing the coordination result to the target network device. In some embodiments of the present disclosure, if the terminal device detects that its transmission capability is exceeded, it does not initiate RRC re-establishment but instead falls back to Make-Before-Break operation, falls back to legacy handover operation, negotiates with the source base station before accessing the target network device, or performs simultaneous connectivity based handover using down transmission parameter configuration for the source network device or for both of the source and target network devices. In such a way, it could achieve a simultaneous connectivity based handover with a reduced delay by means of the proposed capability coordination, and it is also possible to further reduce the transmission delay by means of the proposed processing in case of the UE's capability being exceeded.

Hereinafter, reference will be further made to accompanying drawings to describe the solutions as proposed in the present disclosure in details. However, it shall be appreciated that the following embodiments are given only for illustrative purposes and the present disclosure is not limited thereto. In addition, the solution as provided herein can be used in both the LTE system (like LTE Rel.) and the NR system.

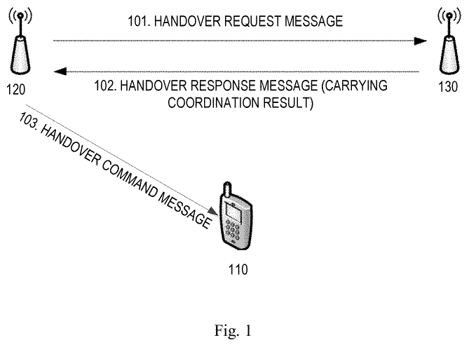

Reference will be first made to FIG. 1 to describe an example solution of simultaneous connectivity based handover according to embodiments of the present disclosure, wherein the capability coordination is performed at the target network device. As illustrated in FIG. 1, a terminal device 110 is a terminal device (such as UE) to be handed over, a network device 120 is a base station (such as eNB or gNB) functioning as a source network device of the handover, and a network device 130 is also a base station (such as eNB or gNB) but functioning as a target network device of the handover.

When the network device 120, as the source network device, makes a handover decision, it transmits a handover request message 101 to the network device 130 to which the terminal device is to be handed over. The handover request message 101 may be, for example, an inter-node handover preparation Information message. In the handover request message 101, it may contain the terminal device's transmission capability, optional current transmission parameter configuration for the source terminal device and an optional simultaneous connectivity indication. The terminal device's transmission capability is used to indicate the transmission capability of terminal device, for example, the maximum transmit power, the maximum number of transmit bits for DL and UL data transmission, supported subcarriers, supported band combination, supported feature set combination, supported PDCP/RLC/MAC/PHY capabilities, etc. The current transmission parameter configuration for the source terminal device is used to indicate the transmission parameter configuration currently used for data communication with the terminal device, such as the transmission power, bands, feature set, etc. The simultaneous connectivity indication may use one bit to indicate whether the handover request is a simultaneous connectivity based handover. However, it shall be appreciated that such simultaneous connectivity indication is not necessary, since the handover message itself can indicate whether it is a simultaneous connectivity based handover, by for example its specific message format, transmission type, and etc.

In response to receipt of the handover request message 101, the network device 130 performs capacity coordination based on the terminal device's transmission capability. Optionally, it may be also further based on the current transmission parameter configuration for the source terminal device for example when the target network device can read configuration information of the source network device like bands, feature set, etc.

Particularly, the network device may determine capability to be used itself by considering from example the terminal device's capability, the current transmission parameter configuration for the source network device, etc. At this point, it is allowed that the transmission parameter configuration for the target network device and the current transmission parameter configuration for the source network device to exceed the transmission capability of the terminal device. In other words, the network device 130 can determine its transmission capability larger than the current remaining capability of the UE (i.e. the transmission capacity consumed by the source network device 120 being subtracted from the UE's capability). If the target network device can read configuration information for the source network device, it could determines its bands, the feature set, etc. based on bands, feature set for the source network device.

Then, the network device may further determine the capability coordination result. Particularly, the network device may determine, based on the capability to be used itself and the terminal device's transmission capability, the band combination, the feature set combination, the maximum number of transmission block bits that can be used for the source network device 120 for Uplink (UL) and Downlink (DL) transmission, uplink transmission power coordination information indicating the power control mode to be used in the simultaneous connectivity. The uplink transmission power coordination information is used to indicate the power control mode to be used in the simultaneous connectivity, and may contain for example various parameters and configuration to be used in the power control mode for both the primary cell and the secondary cell.

Thus, the transmission capability coordination result includes any of the following information:
information on band combination index and feature set combination index that can be used for the source network device;
uplink transmission power coordination information; and
a maximum number of transmission block bits that can be scheduled within in a transmission time interval (TTI) for the source network device.

After the capability coordination is complete, the network device 130 transmits a handover response message 102 to the source network device 120. In the handover response message 102 is contained the transmission parameter configuration for the target network device and the transmission capability coordination result. The handover response message 102 can be for example an inter-node HandoverCommand message. In other word, the transmission parameter configuration for the target network device and the transmission capability coordination result can be transmitted to the source network device over the inter-node HandoverCommand message.

Once receiving the handover response message 102, the network device 120 determines whether the current transmission parameter configuration therefor and the transmission parameter configuration for the target network device exceed the transmission capability of the terminal device. If the transmission capability of the terminal device is exceeded, the network device 130 determines transmission parameter reconfiguration for the network device based on the transmission capability coordination result. In other word, the current transmission parameter configuration will be adjusted to ensure the transmission capability of the terminal device is not exceeded. In some embodiments, transmission parameter reconfiguration for the network device may be determined based on the transmission capability coordination result and the transmission parameter configuration for the network device 130, for example, when it requires changing or release Scell(s) used for the source network device.

After that, the network device 120 transmits a handover command message 103 to the terminal device 110. The handover command message 103 can be transmitted in a Radio Resource Control (RRC) message. The handover command message 103 may contain the transmission parameter configuration for the target network device and the transmission parameter reconfiguration for the source network device (if transmission parameter configuration for the network device 120 was adjusted to ensure the terminal device's capability is not exceeded).

The terminal device 110 receives the handover command message 103 from the network device 120 and performs the simultaneous connectivity based handover based on the transmission parameter configuration for the target network device and transmission parameter configuration for the source network device. The transmission parameter configuration for the source network device used by the terminal device can be currently used parameter configuration for the network device 120, for example, when transmission parameter configuration for the network device 110 is not required to be updated. The transmission parameter configuration for the source network device used by the terminal device can also be transmission parameter reconfiguration for the source network device, for example when transmission parameter configuration for the network device 110 is updated.

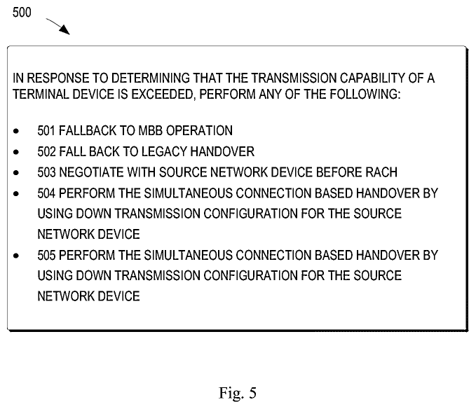

In some embodiments of the present disclosure, in response to determining that the transmission capability of a terminal device is exceeded, the terminal device does not initiate RRC re-establishment but continues the handover process. For example, the terminal device may fall back to Make-Before-Break (MBB) operation, fall back to legacy handover operation, negotiate with the source base station before accessing the target network device, or perform simultaneous connectivity based handover using down transmission parameter configuration for the source network device or for both of the source and target network devices. The processing in case of the UE's capability being exceeded will be described in more details hereinafter with reference to FIG. 5 an thus detailed description thereof will be omitted herein.

By means of the above handover solution, it could achieve a simultaneous connectivity based handover with a reduced delay, and it could further reduce the transmission delay by means of the proposed processing in case of the UE's capability being exceeded.

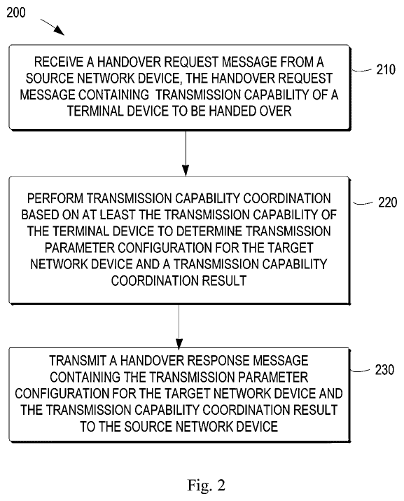

Next, reference will be made to FIGS. 2 to 5 to respectively describe operations at the target network device, the source network device, and the terminal device. It shall be appreciated that these embodiments are only given for illustration purposes and the present application is not limited thereto.

FIG. 2 illustrates a method for simultaneous connectivity based handover at the target network device according to embodiments of the present disclosure. As illustrated in FIG. 2, in block 210, a handover request message is received from a source network device. The handover request message contains transmission capability of terminal device and optional current transmission parameter configuration for the source network device. The handover request message may be, for example but not limited to, an inter-node HandoverPreparationInformation message. That is to say, current transmission parameter configuration for the source network device and transmission capability of terminal device can be received over an inter-node HandoverPreparationInformation message. The terminal device's transmission capability may include, for example but limited to, the maximum transmit power, the maximum number of transmit bits for DL and UL data transmission, supported subcarriers, supported band combination, supported feature set combination, supported PDCP/RLC/MAC/PHY capabilities etc. The current transmission parameter configuration for the source terminal device may include, for example but limited to, the transmission power, bands, feature set, etc.

The handover request message may optionally contain a simultaneous connectivity indication, which may use, for example but not limited to, one bit to indicate whether the handover request is a simultaneous connectivity based handover. The target network device may perform transmission capability coordination in response to receipt of the simultaneous connectivity indication. However, it shall be appreciated that such simultaneous connectivity indication is not necessary, since the handover message itself can indicate whether it is a simultaneous connectivity based handover, by for example its specific message format, transmission type and etc.

Then, in block 220, the target network device performs transmission capability coordination based on at least the transmission capability of the terminal device and optionally on the current transmission parameter configuration for the source network device, in order to determine transmission parameter configuration for the target network device and a transmission capability coordination result.

In response to the receipt of the handover request message, the target network device performs a responsive action, based on at least the transmission capability of the terminal device and optionally on the current transmission parameter configuration for the source network device, to determine transmission parameter configuration for the target network device and the remaining transmission capability or the maximum transmission parameter configuration available for the source network device.

The target network device may determine capability to be used for itself by considering, from example, the terminal device's capability. If the target network device can read configuration information for the source network device, it could determines its bands, the feature set, etc. based on bands, feature set for the source network device. At this point, the transmission parameter configuration for the target network device and the current transmission parameter configuration for the source network device are allowed to exceed the transmission capability of the terminal device. In other words, the target network device can determine its transmission capability larger than the current remaining capability of the terminal device (subtracting capability consumed by the current transmission parameter configuration for the source network device 120 from the terminal device's capability). This lies in that in the later stage, the source network device could further adjust its transmission capability to ensure the terminal device's capability is not exceeded.

Based on the determined transmission capability and the terminal device's capability, the target network device may further determine the capability coordination result. Particularly, the network device may determine, based on the capability to be used for itself and the terminal device's transmission capability, the band combination and the feature set combination that can work with the source network device, the remaining number of transmission block bits that can be used for the source network device, and uplink transmission power coordination information, etc. The uplink transmission power coordination information is used to indicate the power control mode to be used in the simultaneous connectivity, and may contain for example various parameters and configuration to be used in the power control mode for both the primary cell and the secondary cell.

Thus, the transmission capability coordination result may include any of:
information on band combination index and feature set combination index that can be used for the source network device;
uplink transmission power coordination information; and
a maximum number of transmission block bits that can be scheduled within in a transmission time interval (TTI) for the source network device.

Next, in block 230, the target network device transmits a handover response message to the source network device. The handover response message may contain the determined transmission parameter configuration for the target network device and the transmission capability coordination result. The handover response message may be an inter-node HandoverCommand message, in response to which the source network device could continue the follow handover procedure.

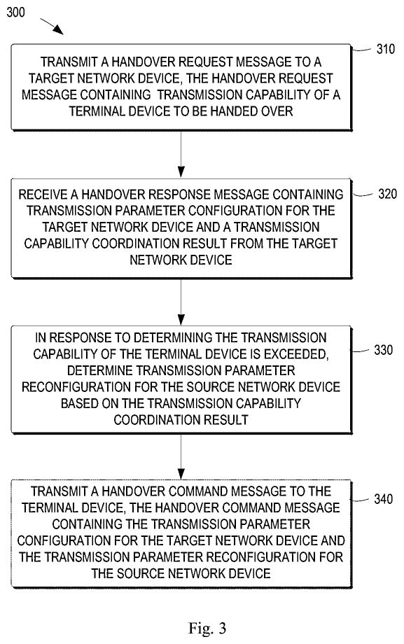

FIG. 3 illustrates a method for simultaneous connectivity based handover at the source network device according to embodiments of the present disclosure. As illustrated in FIG. 3, in block 310, the source network device transmits a handover request message to the target network device. The handover request message may contain transmission capability of a terminal device to be handed over and optionally current transmission parameter configuration for the network device. The handover request message may be, for example but not limited to, an inter-node HandoverPreparationInformation message. The terminal device's transmission capability may include, for example but limited to, the maximum transmit power, the maximum number of transmit bits for DL and UL data transmission, supported subcarriers, supported band combination, supported feature set combination, supported PDCP/RLC/MAC/PHYcapabilities, etc. The current transmission parameter configuration for the source terminal device may include for example but limited to the transmission power, bands, feature set, etc.

The handover request message may optionally contain a simultaneous connectivity indication, which may use one bit to indicate whether the handover request is a simultaneous connectivity based handover. In such a way, the target network device performs transmission capability coordination in response to receipt of the simultaneous connectivity indication. However, it shall be appreciated that such simultaneous connectivity indication is not necessary, since the handover message can indicate whether it is a simultaneous connectivity based handover, by for example its specific message format, transmission type, etc.

Then in block 320, the source network device receives, from the target network device, a handover response message containing transmission parameter configuration for the target network device and a transmission capability coordination result. The handover response message can be for example an inter-node HandoverCommand message. In other word, the transmission parameter configuration for the target network device and the transmission capability coordination result can be received at the source network device in the inter-node HandoverCommand message. The transmission capability coordination result may include any of:
information on band combination index and feature set combination index that can be used for the source network device;
uplink transmission power coordination information; and
a maximum number of transmission block bits that can be scheduled within in a transmission time interval (TTI) for the source network device.

Next, in block 330, the source network device determines, in response to determining that the transmission capability of the terminal device is exceeded, transmission parameter reconfiguration for the network device based on the transmission capability coordination result.

Once receiving the handover response message, the source network device determines whether its current transmission parameter configuration and the transmission parameter configuration for the target network device exceed the transmission capability of the terminal device. In this handover solution, the transmission parameter configuration for the target network device and the current transmission parameter configuration for the source network device transmitted to the target network device are allowed to exceed the transmission capability of the terminal device during the capability coordination. Thus, if the transmission capability of the terminal device is exceeded, the source network device will determine transmission parameter reconfiguration for the network device based on the transmission capability coordination result. In other word, a new transmission configured may be determined by adjusting current transmission parameter configuration to ensure the transmission capability of the terminal device is not exceeded.

On the other hand, if the terminal device capability is not exceeded, the source network device could just maintain the current transmission parameter configuration without further adjustment. However, it shall be understood that the present application is not limited thereto, as an alternative solution, the source network device could also adjust its transmission parameter configuration even if the UE capability is not exceeded. That is to say, the source network could directly determine its transmission capability and new transmission parameter configuration in response to receipt of the handover response message, without determining whether the UE capability is not exceeded or not.

In some embodiments of the present disclosure, the source network device may determine the transmission parameter reconfiguration for the network device based on the transmission capability coordination result and the transmission parameter configuration for the target network device, for example, when it requires changing or releasing scell(s) used by the source network device.

In block 340, the source network device transmits a handover command message to the terminal device 110. The handover command message can be transmitted in a Radio Resource Control (RRC) message. The handover command message may contain the transmission parameter configuration for the target network device and the transmission parameter reconfiguration for the source network device if transmission parameter configuration for the network device 120 was adjusted. By means of the transmission parameter configuration for the target network device and the source network device, the terminal device may perform the simultaneous connectivitys based hand over.

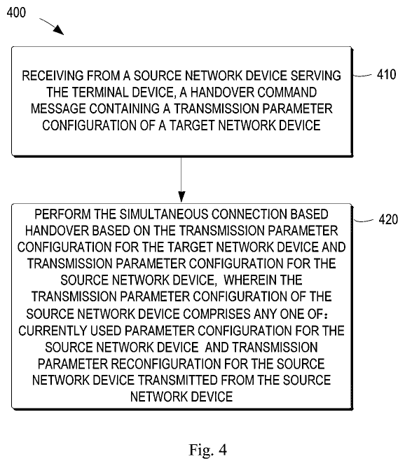

FIG. 4 illustrates a method for simultaneous connectivity based handover at the terminal network device according to embodiments of the present disclosure. As illustrated in FIG. 4, in block 410, the terminal device receives from a source network device serving the terminal device, a handover command message containing a transmission parameter configuration for a target network device. The handover command message can be transmitted in, for example but not limited to, a Radio Resource Control (RRC) message. The handover command message may contain the transmission parameter configuration for the target network device and the transmission parameter reconfiguration for the source network device if transmission parameter configuration for the network device 120 was adjusted to ensure the terminal device's capability is not exceeded.

Then in block 420, the terminal device performs the simultaneous connectivity based handover based on the transmission parameter configuration for the target network device and transmission parameter configuration for the source network device. As mentioned above, the handover command massage contains a transmission parameter configuration for the target network device. Thus, the terminal device could perform the simultaneous connectivity based handover using the transmission parameter configuration for the target network device as well as transmission parameter configuration for the source network device. The used transmission parameter configuration for the source network device can be currently used parameter configuration for the network device 120, for example, when transmission parameter configuration for the network device 110 is required to update. The used transmission parameter configuration for the source network device can also be transmission parameter reconfiguration for the source network device, for example when transmission parameter configuration for the network device 110 was updated.

In some embodiments of the present disclosure, the transmission capability of a terminal device might be exceeded. That might happen for example when no capability coordination is performed between the source and target network devices, or when the capacity coordination is performed but does work well. In some embodiments of the present disclosure, in response to determining that the transmission capability of a terminal device is exceeded, the terminal device will not initiate RRC re-establishment but perform a special handover process as proposed therein. For illustration purposes, reference will be then made to FIG. 5 to describe some example handover processes 500 according to embodiments of the present disclosure.

As illustrated in FIG. 5, as an option 501, the terminal device may fall back to Make-Before-Break (MBB) operation in response to determining that the terminal device's capability is exceeded. In the MBB operation, the terminal device breaks the connection with the source network device only right before initiating access to the target network device. In the MBB operation, the terminal device may perform data transmission only with the source network device using the transmission parameter configuration for the source network device. In other words, if the handover command message for simultaneous connectivity exceeds the UE's capability, the UE could perform data transmission only with the source eNB by applying the transmission parameter configuration for the source network device.

When it is ready to establish connection with the target network device, the network device may release connection with the source network device. For example, before initiating Random Access to the target network device, the terminal device could release the connection with source network device, reset Media Access Control (MAC) entity, re-establish Packet Data Convergence Protocol (PDCP) entity and Radio Link Control (RLC) entity. Then it could break the connection with the source network and initiate the access process by applying the transmission parameter configuration for the target network device.

Optionally, upon connecting to the target network device successfully, the terminal device may transmit a connection release indication to the target network device to indicate that the connection with the source network device was already released. The indication can be transmitted to the target network device in for example an RRCReconfigurationComplete message. In this way, there is no need for the target network to send a RRC message to the terminal device to command it to release the source network device. Therefore, the target network device can initiate path switch immediately.

Once connecting to the target network device, the network device could perform data transmission with the target network device by applying the transmission parameter configuration for the target network device.

It can be appreciated that during the above procedure, the terminal device never applies transmission parameter configuration for the target network device and transmission parameter configuration for the source network device at the same time, and thus for UL transmission, the terminal device can use the full UL power for either of network devices. Further, such a procedure is totally transparent to both network devices and thus the two network devices can still follow the procedure of simultaneous connectivity based handover.

FIG. 5 also illustrates another option 502 for the terminal device in case of the terminal device's capability is exceeded, i.e., falling back to legacy handover operation. In the legacy handover operation, the terminal device will release connection with the source network device once receiving the handover command from the source network. Then it may begin to establish connection with the target network device with the transmission configuration for the target network device. Particularly, the terminal device could reset MAC entity, re-establish PDCP entity and RLC entity. Then, it could initiate the access process by applying the transmission parameter configuration for the target network device.

Optionally, upon connecting to the target network device successfully, the terminal device may transmit a connection release indication to the target network device to indicate that the connection with the source network device was already released. The indication can be transmitted to the target network device in for example an RRCReconfigurationComplete message. In this way, there is no need for the target network to send a RRC message to the terminal device to command it to release the source network device. Thus, the target network device can initiate path switch immediately.

Once connecting to the target network device, the network device could perform data transmission with the target network device by applying the transmission parameter configuration for the target network device.

It can be appreciated that similar to option 501 in the option 502, the terminal device never applies transmission parameter configuration for the target network device and transmission parameter configuration for the source network device at the same time, and thus for UL transmission, the terminal device can use the full UL power for either of network devices. Further, such a procedure is also totally transparent to both network devices and thus the two network devices can still follow the procedure of simultaneous connectivity based handover.

As illustrated in FIG. 5, as a further option 503, the terminal device may negotiate with the source base station before accessing the target network. In this solution, the terminal device will try to negotiate with the source base station to obtain a new transmission parameter configuration for the source base station so that the terminal device's capability is not exceeded.

Particularly, if the terminal device receives the handover command message, it performs data transmission only with the source network device with the transmission parameter configuration for the source network device. That means the terminal device will only apply the transmission parameter configuration for the source network device, and continue data transmission with the source network device. At the same time, the terminal device will transmit a capability exceeding indication to the source network device and provide proposed configuration for the source network device. The capability exceeding indication can be transmitted using for example a UEassistInformation message, and it may contain any of:

Reduced UL power of source eNB

Suggested carrier aggregation (CA) configuration for the source eNB

Reduced Multiple Input Multiple Output (MIMO) layer number of each cell

The source network may adjust its transmission parameter configuration to obtain a transmission parameter reconfiguration and send a reconfiguration message to the terminal device.

The terminal device may receive the reconfiguration message. If the terminal device receives the reconfiguration for the source eNB before initiating Random Access to the target network device, the terminal device can apply the new reconfiguration for the source network device if the terminal device's capability is not exceeded. In other words, simultaneous connectivity based handover can be performed with the transmission parameter reconfiguration for the source network device and the transmission parameter configuration for the target network device. On the other hand, if the terminal device's capability is still exceeded, the terminal device could initiate an RRC-reestablishment, fall back to MBB operation, fall back to the legacy handover operation, or any other alternative operation.

In addition, FIG. 5 illustrates a yet further option 504 for the terminal device, wherein the terminal device may perform the simultaneous connectivity based connection using a down transmission parameter configuration for the source network device. That is to say, it could perform the simultaneous connectivity based handover using the transmission parameter configuration for the target network device and a down transmission parameter configuration lower than the transmission parameter configuration for the source network device.

Thus, in this case, the terminal device can down the transmission parameter configuration for the source network device. Particularly, the terminal device may perform any one or more of the following operation to support simultaneous connectivity with source and target network device: reducing UL transmission power for the source network device, reducing number of serving cells of source network device (may keep only primary cell (Pcell) of source network device in active state, for example), reducing the MIMO layer number for the source network device, and etc.

However, if UE is still unable to perform simultaneous connectivity based handover using down configuration, then it may fall back to MBB operation, the legacy handover process, initiate RRC re-establishment, or any other suitable operation.

As a yet further option 505 as illustrated in FIG. 5, the terminal device may perform the simultaneous connectivity based connection using a down transmission parameter configuration for both the source network device and the target network device. That is to say, the terminal device could perform the simultaneous connectivity based handover using a down transmission parameter configuration lower than the transmission parameter configuration for the target network device and a down transmission parameter configuration lower than the transmission parameter configuration for the source network device. For example, the terminal device may perform any one or more of the following operation: reducing UL transmission power for the source and/or target network device, reducing number of serving cells of source and/or target network device (may keep only primary cells (Pcells) of source and target network device in active state, for example), reducing the MIMO layer number for the source and/or target network device, and etc.

Thus in this case, the terminal device can down the transmission parameter configuration for the source network device and the target network device. Particularly, the terminal device may only keep PCell of both source and target network devices in active state and the secondary cell(s) (SCell(s)) of the source and target network device should remain in deactivated state during HO execution period. For example, the terminal device can also adjust the UL power to be used for the source network and target network if the configuration received exceeds the total uplink power capability of the terminal device. After the source network device is released, the terminal device may activate the Scell(s) of the target network device. Optionally, it is also possible to adjust the UL power for the target network device back to the Full UL power. In addition, it is also possible to perform, after the source network device is released, the data communication with the target network device by applying the transmission parameter configuration as contained within the handover command message initially received from the source network device.

By means of the above handover solution, it could achieve a simultaneous connectivity based handover with a reduced delay and it could further reduce the transmission delay by means of the proposed processing in case of the UE's capability being exceeded.

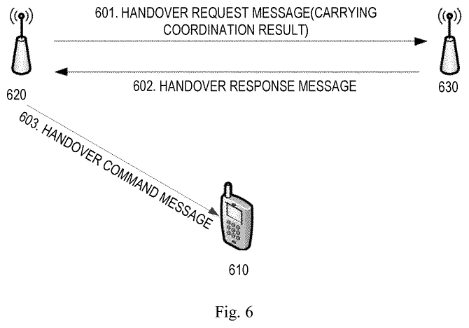

FIG. 6 further illustrates another example solution of simultaneous connectivity based handover according to embodiments of the present disclosure. Different from the solution as illustrated in FIG. 1, the capability coordination is performed at the source network device, and thus the handover request message 601 and the handover response message 602 contain different information from those messages 101 and 102 and the target network device needs to determine its transmission parameter configuration based on the capability coordination result. Hereinafter, only these different operations are described and for those similar ones, the skilled in the art may refer to description with reference to FIGS. 1 to 5.

In the solution as illustrated in FIG. 6, the source network device 620 first performs transmission capability coordination in response to a handover decision. The capability coordination operation herein is similar to those performed at the target network device described with reference to FIGS. 1 and 2. Particularly, the source network device 620 will first determine targeted transmission parameter configuration to be used for itself and then determine the coordination result based on its targeted transmission parameter configuration and the terminal device's capability. For example, the network device 620 may determine the band combination, the feature set combination, the maximum number of transmission block bits that can be used by the target network device 630, uplink transmission power coordination information indicating the power control mode to be used in the simultaneous connectivity.

Thus, the transmission capability coordination result contains information for the target network device and may include any of the following information:
information on band combination index and feature set combination index that can be used for the target network device;
uplink transmission power coordination information; and
a maximum number of transmission block bits that can be scheduled within in transmission time interval (TTI) for the target network device.

After the capability coordination is complete, the network device 620 transmits a handover request message 601 to the network device 130 to which the terminal device is to be handed over. The handover request message 601 may be for example, an inter-node handover preparation Information message. The handover request message 601 may contain transmission capability coordination result, transmission capability of a terminal device to be handed over, and an optional simultaneous connectivity indication. The handover request message further contains targeted transmission parameter configuration for the source network device.

After the network device 630 receives the handover request message, it determines transmission parameter configuration for the network device based on the transmission capability coordination result and transmission capability of the terminal device. In this solution, the transmission parameter configuration for the target network device and the targeted transmission parameter configuration for the source network device are not allowed to exceed the transmission capability of the terminal device.

After determining its transmission parameter configuration, the network device 630 transmits a handover response message 602 to the network device 620. The handover response message 602 contains the transmission parameter configuration for the network device to the source network device.

Upon receipt of the handover response message, the network device 620 may transmit a handover command message to the terminal device, the handover command message 603 containing the transmission parameter configuration for the target network device and the transmission parameter configuration for the source network device. In such a way, the terminal device 610 could perform the simultaneous connectivity based handover according to the transmission parameter configuration for the source and target network devices contained within the handover command message. operations for the terminal device are similar to those in the handover solution described with reference to FIGS. 1 to 5 and thus will be omitted herein.

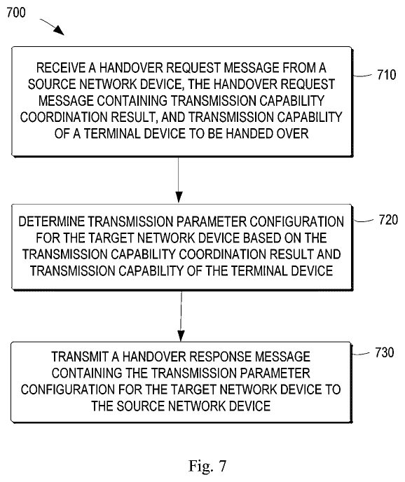

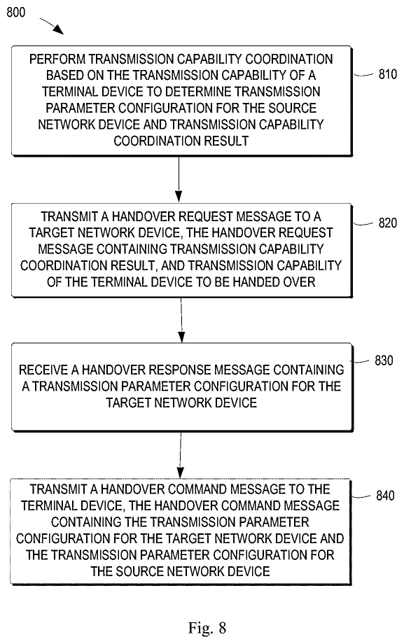

Next, reference will be made to FIGS. 7 to 8 to respectively describe operations at the target network device and the source network device in the solution as illustrated in FIG. 6

FIG. 7 illustrates a method 700 for simultaneous connectivity based handover at the target network device according to embodiments of the present disclosure. As illustrated in FIG. 7, in block 710, the target network device receives a handover request message from a source network device. The handover request message may contain transmission capability coordination result, and transmission capability of a terminal device to be handed over. The handover request message may be, for example but not limited to, an inter-node HandoverPreparationInformation message.

The handover request message may optionally contain a simultaneous connectivity indication, which may use one bit to indicate whether the handover request is a simultaneous connectivity based handover. The target network device performs the following transmission parameter configuration determination in response to receipt of the simultaneous connectivity indication. However, it shall be appreciated that such simultaneous connectivity indication is not necessary, since the handover message itself can indicate whether it is a simultaneous connectivity based handover, by for example its specific message format message, and etc.

In some embodiments, the transmission capability coordination result may include any one or more of:
information on band combination index and feature set combination index that can be used for the target network device;
uplink transmission power coordination information; and
a maximum number of transmission block bits that can be scheduled within in transmission time interval (TTI) for the target network device.

Then, in block 720, the target network device determines transmission parameter configuration for the network device based on the transmission capability coordination result and transmission capability of the terminal device. At this point, the transmission parameter configuration for the target network device and the current transmission parameter configuration for the source network device are not allowed to exceed the transmission capability of the terminal device. In other words, the target network device cannot determine its transmission capability larger than the current remaining capability of the UE (subtracting the targeted transmission parameter configuration for the source network device 620 from the terminal device's capability).

In some embodiment of the present disclosure, the handover request message further contains targeted transmission parameter configuration for the source network device. In such a case, the transmission parameter configuration for the network device may be determined based on the transmission capability coordination result, transmission capability of a terminal device and the targeted transmission parameter configuration for the source network device.

Next, in block 730, the target network device transmits a handover response message to the source network device wherein the handover response message contains the transmission parameter configuration for the network device to the source network device. The handover response message may be, for example, an inter-node HandoverCommand message. In response to the handover response message, the source network device could continue the following handover procedure.

FIG. 8 illustrates a method 800 for simultaneous connectivity based handover at the source network device according to embodiments of the present disclosure. As illustrated in FIG. 8, in block 810, the source network device performs transmission capability coordination based on the transmission capability of the terminal device to determine transmission parameter configuration for the network device and transmission capability coordination result.

In response to a handover decision, the source network device performs a responsive action, based on at least the transmission capability of the terminal device, to determine transmission parameter configuration for the source network device and the remaining transmission capability or the maximum transmission parameter configuration available for the target network device.

Particularly, the source network device will first determine targeted transmission parameter configuration to be used in the simultaneous connectivity based handover. The source network device then determines the coordination result based on its targeted source transmission parameter configuration and the terminal device's capability. For example, the source network device may determine, the band combination, the feature set combination, the maximum number of transmission block bits that can be used for the target network device, uplink transmission power coordination information indicating the power control mode to be used in the simultaneous connectivity.

Thus, the transmission capability coordination result may include any of the following information:
information on band combination index and feature set combination index that can be used for the target network device;
uplink transmission power coordination information; and
a maximum number of transmission block bits that can be scheduled within in transmission time interval (TTI) for the target network device.

Then, in block 820, the source network device transmits a handover request message to a target network device. The handover request message may contain transmission capability coordination result, and transmission capability of a terminal device to be handed over. The handover request message includes inter-node handover preparation information. The handover request message may contain for example transmission capability coordination result, transmission capability of a terminal device to be handed over, and an optional simultaneous connectivity indication.

The handover request message further contains targeted transmission parameter configuration for the source network device so that the target network could further use targeted transmission parameter configuration for the source network device to determine its transmission parameter configuration.

In block 830, the source network device receives a handover response message containing a transmission parameter configuration for the target network device. The handover response message may include an inter-node handover command therein, and thus it could be inter-node HandoverCommand message.

After that, in block 840, the source network device transmits a handover command message to the terminal device, the handover command message containing the transmission parameter configuration for the target network device and the transmission parameter configuration for the source network device. The handover command message may be transmitted in Radio Resource Control (RRC) message.

Hereinbefore, methods 700 and 800 implemented at the source and target network device are described with reference to FIGS. 7 and 8 in brief. It can be appreciated that for details about the operations of methods 700 and 800, one may refer to descriptions of FIG. 6 and those similar operations made with respect to the respective steps of the methods with reference to FIGS. 1 to 5.

In further aspects, apparatuses for performing the method 200 to 400 or 700 to 800 may include means for performing the respective steps of the method 200 to 400 or 700 to 800. The means may be implemented in any suitable form. For example, the means may be implemented in a circuitry or software module.

In an aspect of the present disclosure, there is provided an apparatus for performing the method 200. The apparatus performing the method 200 may include means for receiving a handover request message from a source network device, the handover request message containing transmission capability of a terminal device to be handed over; means for performing transmission capability coordination based on at least the transmission capability of the terminal device to determine transmission parameter configuration for the target network device and a transmission capability coordination result; and means for transmitting a handover response message containing the transmission parameter configuration for the target network device and the transmission capability coordination result to the source network device.

In some embodiments of the present disclosure, the handover request message may further contain a simultaneous connectivity indication, and wherein performing transmission capability coordination may include performing the transmission capability coordination in response to receipt of the simultaneous connectivity indication.

In some embodiments of the present disclosure, the handover request message may further contain current transmission parameter configuration for the source network device and wherein performing transmission capability coordination may include performing the transmission capability coordination based on at least the transmission capability of the terminal device and the current transmission parameter configuration for the source network device.

In some embodiments of the present disclosure, the transmission capability coordination result may include any one or more of: information on band combination index and feature set combination index that can be used for the source network device; uplink transmission power coordination information; and a maximum number of transmission block bits that can be scheduled within in a transmission time interval (TTI) for the source network device.

In some embodiments of the present disclosure, the means for receiving a handover request message may receive an inter-node handover preparation information in the handover request message.

In some embodiments of the present disclosure, the means for transmitting a handover response message may transmit an inter-node handover command in the handover response message.

In some embodiments of the present disclosure, the transmission parameter configuration for the target network device and the current transmission parameter configuration for the source network device are allowed to exceed the transmission capability of the terminal device.

In another aspect of the present disclosure, there is provided an apparatus for performing the method 300. The apparatus performing the method 300 may include means for transmitting a handover request message to a target network device, the handover request message containing transmission capability of a terminal device to be handed over; means for receiving a handover response message containing transmission parameter configuration for the target network device and a transmission capability coordination result from the target network device; and means for, in response to determining that the transmission capability of the terminal device is exceeded, determining transmission parameter reconfiguration for the source network device based on the transmission capability coordination result.

In some embodiments of the present disclosure, the handover request message may further contain any of a simultaneous connectivity indication and current transmission parameter configuration for the source network device.

In some embodiments of the present disclosure, the transmission capability coordination result may include any one or more of: information on band combination index and feature set combination index that can be used for the source network device; uplink transmission power coordination information; and a maximum number of transmission block bits that can be scheduled within in a transmission time interval (TTI) for the source network device.

In some embodiments of the present disclosure, the means for transmitting a handover request message may transmit inter-node handover preparation information in the handover request message.

In some embodiments of the present disclosure, the means for receiving a handover response message may receive an inter-node handover command in the handover response message.

In some embodiments of the present disclosure, the apparatus for performing method 400 may further include means for transmitting a handover command message to the terminal device, the handover command message containing the transmission parameter configuration for the target network device and the transmission parameter reconfiguration for the source network device.

In some embodiments of the present disclosure, the means for transmitting a handover command message may transmit the handover command message in a Radio Resource Control (RRC) message.

In some embodiments of the present disclosure, the means for determining transmission parameter reconfiguration for the source network device may determine transmission parameter reconfiguration for the source network device based on the transmission capability coordination result and the transmission parameter configuration for the target network device.

In some embodiments of the present disclosure, the transmission parameter configuration for the target network device and the current transmission parameter configuration for the source network device transmitted to the target network device can be allowed to exceed the transmission capability of the terminal device.

In a further aspect of the present disclosure, there is provided an apparatus for performing the method 400. The apparatus performing the method 400 may include means for receiving from a source network device serving the terminal device, a handover command message containing a transmission parameter configuration for a target network device; and means for performing the simultaneous connectivity based handover based on the transmission parameter configuration for the target network device and transmission parameter configuration for the source network device. The transmission parameter configuration for the source network device may include any one of currently used transmission parameter configuration for the source network device and transmission parameter reconfiguration for the source network device transmitted from the source network device.

In some embodiments of the present disclosure, the handover command message further may contain the transmission parameter reconfiguration for the source network device.

In some embodiments of the present disclosure, the apparatus for performing the method 400 may further include means for, in response to determining that the transmission capability of the terminal device is exceeded, performing data transmission only with the source network device using the transmission parameter configuration for the source network device; releasing connection with the source network device once it is ready to establish connection with the target network device; and performing data transmission with the target network device using the transmission parameter configuration for the target network device.

In some embodiments of the present disclosure, the apparatus for performing the method 400 may further include means for in response to determining that the transmission capability of the terminal device is exceeded, releasing connection with the source network device; and performing data transmission with the target network device using the transmission parameter configuration for the target network device.

In some embodiments of the present disclosure, the apparatus for performing the method 400 may further include means for transmitting a connection release indication to the target network device upon connecting to the target network device successfully, to indicate that the connection with the source network device is already released.

In some embodiments of the present disclosure, a full uplink transmission power is used for data transmission with either of the source network device and the target network device.

In some embodiments of the present disclosure, the apparatus for performing the method 400 may further include means for, in response to determining that the transmission capability of a terminal device is exceeded, performing data transmission only with the source network device with the transmission parameter configuration for the source network device; transmitting a capability exceeding indication to the source network device and providing proposed configuration for the source network device; receiving, from the source network device, a reconfiguration message indicating transmission parameter reconfiguration for the source network device; and performing, in response to determining that the transmission capability of a terminal device is not exceeded, simultaneous connectivity based handover with the transmission parameter reconfiguration for the source network device and the transmission parameter configuration for the target network device.

In some embodiments of the present disclosure, the apparatus for performing the method 400 may further include: means for, in response to determining that the transmission capability of the terminal device is exceeded, performing the simultaneous connectivity based handover using the transmission parameter configuration for the target network device and a down transmission parameter configuration lower than the transmission parameter configuration for the source network device.

In some embodiments of the present disclosure, the terminal device may be connected with only a primary cell of the source network device during the simultaneous connectivity based handover.

In some embodiments of the present disclosure, the apparatus for performing the method 400 may further include: means for, in response to determining that the transmission capability of the terminal device is exceeded, performing the simultaneous connectivity based handover using a down transmission parameter configuration lower than the transmission parameter configuration for the target network device and a down transmission parameter configuration lower than the transmission parameter configuration for the source network device.

In some embodiments of the present disclosure, the terminal device may be connected with only a primary cell of the source network device and a primary cell of the target network device during the simultaneous connectivity based handover; and/or wherein uplink transmission power to be used for the source network device and the target network device can be adjusted so that the total transmission power of the terminal device is not exceeded; and/or wherein a secondary cell of the target network device can be activated after the source network device may be released.

In a still further aspect of the present disclosure, there is provided an apparatus for performing the method 700. The apparatus for performing the method 700 may include means receiving a handover request message from a source network device, the handover request message containing transmission capability coordination result, and transmission capability of a terminal device to be handed over; means for determining transmission parameter configuration for the target network device based on the transmission capability coordination result and the transmission capability of the terminal device; and means for transmitting a handover response message containing the transmission parameter configuration for the target network device to the source network device.

In some embodiments of the present disclosure, the handover request message may further contain a simultaneous connectivity indication, and the means for determining transmission parameter configuration for the target network device may determine the transmission parameter configuration for the target network device in response to receipt of the simultaneous connectivity indication.

In some embodiments of the present disclosure, the handover request message may further contain targeted transmission parameter configuration for the source network device. In such a case, the means for determining transmission parameter configuration for the target network device may determine the transmission parameter configuration for the target network device based on the transmission capability coordination result, the transmission capability of the terminal device and the targeted transmission parameter configuration for the source network device.

In some embodiments of the present disclosure, the transmission capability coordination result includes any one or more of: information on band combination index and feature set combination index that can be used for the target network device; uplink transmission power coordination information; and a maximum number of transmission block bits that can be scheduled within in transmission time interval (TTI) for the target network device.

In some embodiments of the present disclosure, the means for receiving a handover request message may receive an inter-node handover preparation information in the handover request message.

In some embodiments of the present disclosure, the means for transmitting a handover response message may transmit an inter-node handover command in the handover response message.

In some embodiments of the present disclosure, the transmission parameter configuration for the target network device and the current transmission parameter configuration for the source network device can not allowed to exceed the transmission capability of the terminal device.

In a yet further aspect of the present disclosure, there is provided an apparatus for performing the method 800. The apparatus for performing the method 800 may include means for performing transmission capability coordination based on the transmission capability of a terminal device to determine transmission parameter configuration for the source network device and transmission capability coordination result; means for transmitting a handover request message to a target network device, the handover request message containing transmission capability coordination result, and the transmission capability of the terminal device to be handed over; and means for receiving a handover response message containing a transmission parameter configuration for the target network device.

In some embodiments of the present disclosure, the handover request message may further contain a simultaneous connectivity indication.

In some embodiments of the present disclosure, the handover request message may further contain targeted transmission parameter configuration for the source network device.

In some embodiments of the present disclosure, the transmission capability coordination result may include any one or more of: information on band combination index and feature set combination index that can be used for the target network device; uplink transmission power coordination information; and a maximum number of transmission block bits that can be scheduled within in transmission time interval (TTI) for the target network device.

In some embodiments of the present disclosure, the means for transmitting a handover request message may transmit inter-node handover preparation information in the handover request message.

In some embodiments of the present disclosure, the means for receiving a handover response message may receive an inter-node handover command in the handover response message.

In some embodiments of the present disclosure, the apparatus for performing the method 800 may further include: means for transmitting a handover command message to the terminal device, the handover command message containing the transmission parameter configuration for the target network device and the transmission parameter configuration for the source network device.

In some embodiments of the present disclosure, the means for to transmitting a handover command message may transmit the handover command message in Radio Resource Control (RRC) message.

In some embodiments of the present disclosure, the transmission parameter configuration for the target network device and the targeted transmission parameter configuration for the source network device can not allowed to exceed the transmission capability of the terminal device.

Hereinbefore, the apparatuses for performing methods 200 to 400 and 700 to 800 are described in brief. It can be noted that for details about operations of these apparatuses, one may refer to descriptions of the respective steps of the methods with reference to FIGS. 1 to 8.

Those skilled in the art will appreciate that the aforesaid examples are only for illustration not limitation and the present disclosure is not limited thereto; one can readily conceive many variations, additions, deletions and modifications from the teaching provided herein and all these variations, additions, deletions and modifications fall the protection scope of the present disclosure.

In addition, in some embodiment of the present disclosure, these apparatuses may include at least one processor. The at least one processor suitable for use with embodiments of the present disclosure may include, by way of example, both general and special purpose processors already known or developed in the future. These apparatuses may further include at least one memory. The at least one memory may include, for example, semiconductor memory devices, e.g., RAM, ROM, EPROM, EEPROM, and flash memory devices. The at least one memory may be used to store program of computer executable instructions. The program can be written in any high-level and/or low-level compliable or interpretable programming languages. In accordance with embodiments, the computer executable instructions may be configured, with the at least one processor, to cause these apparatuses to at least perform operations according to the method as discussed with reference to FIGS. 1 to 8 respectively.

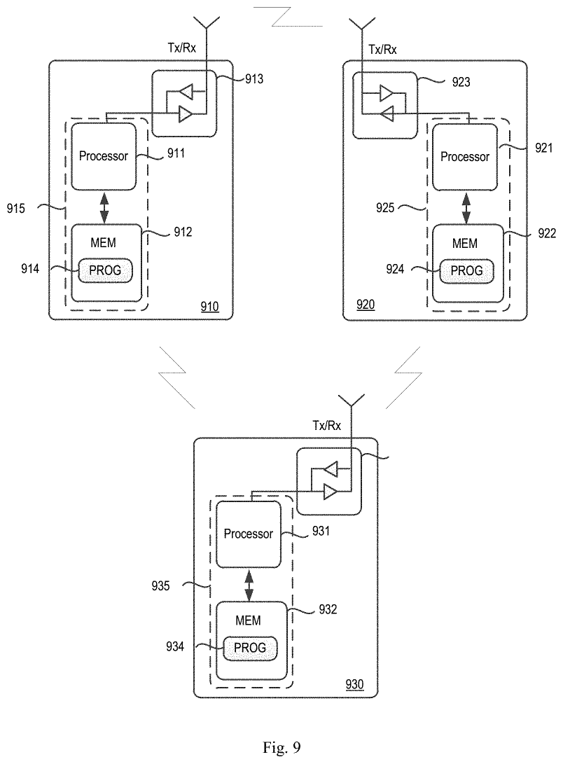

FIG. 9 schematically illustrates a simplified block diagram of a communication system 900 that can implement the simultaneous connectivity based handover process according to embodiments of the present disclosure. The communication system 900 include an apparatus 910 that may be embodied as or included in a target network device like the target eNB or gNB, an apparatus 920 that may be embodied as or included in a source network device like source eNB or gNB, and an apparatus 920 that may be embodied as or included in a terminal device like UE described herein.

The apparatus 910 includes at least one processor 911, such as a data processor (DP) and at least one memory (MEM) 912 coupled to the processor 911. The apparatus 910 may further include a transmitter TX and receiver RX 913 coupled to the processor 911, which may be operable to communicatively connect to the apparatus 920 and 930. The MEM 912 stores a program (PROG) 914. The PROG 914 may include instructions that, when executed on the associated processor 911, enable the apparatus 910 to operate in accordance with embodiments of the present disclosure, for example method 200 or 700. A combination of the at least one processor 911 and the at least one MEM 912 may form processing means 915 adapted to implement various embodiments of the present disclosure.

The apparatus 920 includes at least one processor 921, such as a DP, and at least one MEM 922 coupled to the processor 921. The apparatus 920 may further include a suitable TX/RX 923 coupled to the processor 921, which may be operable for wireless communication with the apparatuses 910 and 930. The MEM 922 stores a PROG 924. The PROG 924 may include instructions that, when executed on the associated processor 921, enable the apparatus 920 to operate in accordance with the embodiments of the present disclosure, for example the method 300 or 800. A combination of the at least one processor 921 and the at least one MEM 922 may form processing means 925 adapted to implement various embodiments of the present disclosure.

The apparatus 930 includes at least one processor 931, such as a DP, and at least one MEM 932 coupled to the processor 931. The apparatus 930 may further include a suitable TX/RX 933 coupled to the processor 931, which may be operable for wireless communication with the apparatuses 910 and 920. The MEM 932 stores a PROG 934. The PROG 934 may include instructions that, when executed on the associated processor 931, enable the apparatus 930 to operate in accordance with the embodiments of the present disclosure, for example the method 400. A combination of the at least one processor 931 and the at least one MEM 932 may form processing means 935 adapted to implement various embodiments of the present disclosure.

Various embodiments of the present disclosure may be implemented by computer program executable by one or more of the processors 911, 921, and 931, software, firmware, hardware or in a combination thereof.

The MEMs 912, 922 and 932 may be of any type suitable to the local technical environment and may be implemented using any suitable data storage technology, such as semiconductor based memory devices, magnetic memory devices and systems, optical memory devices and systems, fixed memory and removable memory, as non-limiting examples.

The processors 911, 921 and 931 may be of any type suitable to the local technical environment, and may include one or more of general purpose computers, special purpose computers, microprocessors, digital signal processors DSPs and processors based on multicore processor architecture, as non-limiting examples.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1-33. (canceled)

34. A network device comprising a processor configured to:
transmit, to a target network device, a handover request message comprising coordination information and an indication indicating simultaneous connection based handover;
receive, from the target network device, a handover response message; and
transmit, to a terminal, a handover command message.

35. The network device according to claim 34, wherein
the coordination information is included in handover preparation information in the handover request message.

36. The network device according to claim 34, wherein
the coordination information comprises uplink power coordination information between the network device and the target network device.

37. The network device according to claim 34, wherein
the coordination information comprises a maximum number of transmission block bits that can be scheduled in a Transmission Time Interval (TTI) for the target network device.

38. A method comprising:
transmitting, to a target network device, a handover request message comprising coordination information and an indication indicating simultaneous connection based handover;
receiving, from the target network device, a handover response message; and
transmitting, to a terminal, a handover command message.

39. The method according to claim 38, wherein
the coordination information is included in handover preparation information in the handover request message.

40. The method according to claim 38, wherein
the coordination information comprises uplink power coordination information between a source network device and the target network device.

41. The method according to claim 38, wherein
the coordination information comprises a maximum number of transmission block bits that can be scheduled in a Transmission Time Interval (TTI) for the target network device.
